(19) United States
(12) Patent Application Publication
(10) Pub. No.: US 2015/0091862 A1
(43) Pub. Date: Apr. 2, 2015

(54) LOGIC FOR CHANGING MODES OF OPERATION OF A TOUCH AND PROXIMITY SENSOR THAT CAN CHANGE SENSITIVITY

(71) Applicant: Cirque Corporation, Salt Lake City, UT (US)

(72) Inventor: Jon Alan Bertrand, Taylorsville, UT (US)

(21) Appl. No.: 14/500,565

(22) Filed: Sep. 29, 2014

Related U.S. Application Data
(60) Provisional application No. 61/883,900, filed on Sep. 27, 2013.

(51) Int. Cl. G06F 3/044

(52) U.S. Cl. CPC G06F 3/044
USPC 345/174

(57) ABSTRACT

A system and method for changing a mode of operation of a touch and proximity sensor depending upon the strength of a signal from a detectable object relative to the touch and proximity sensor, wherein the system and method changes sensitivity of the touch and proximity sensor by switching between discrete sensitivity modes of operation as the distance of the object in a three dimensional volume of space above the touch and proximity sensor changes, to thereby enable the touch and proximity sensor to accurately detect and the track a presence of one or more objects.

### BACKGROUND OF THE INVENTION

1. Field of the Invention

This invention relates generally to touch and proximity sensors. Specifically, the invention pertains to capacitance sensitive touch and proximity sensors that can perform touch and proximity sensing of one or more objects, and the logic used to change between the different modes of operation which controls sensitivity of the sensor as the distance to a detectable object changes.

2. Description of Related Art

There are several designs for capacitance sensitive touch sensors. It is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

### BRIEF SUMMARY OF THE INVENTION

In a first embodiment, the present invention is a system and method for changing a mode of operation of a touch and proximity sensor, the mode of operation being dependent upon the strength of a signal from a detectable object relative to the touch and proximity sensor, wherein the system and method changes sensitivity of the touch and proximity sensor by switching between discrete sensitivity modes of operation as the distance of the object in a three dimensional volume of space above the touch and proximity sensor changes, to thereby enable the touch and proximity sensor to accurately detect and the track a presence of one or more objects.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

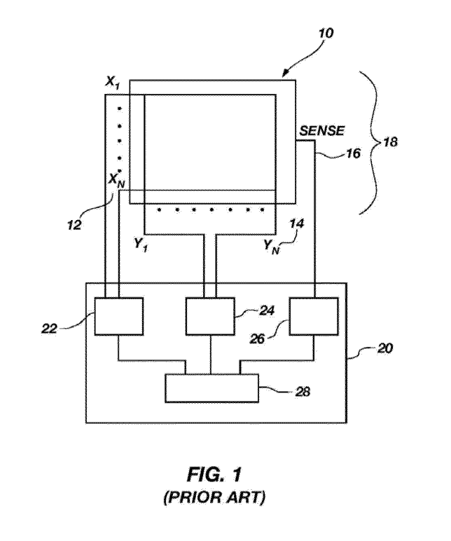

FIG. 2 is a block diagram of a first embodiment of the present invention showing off-board projection electrodes.

FIG. 3 is a block diagram of a first embodiment of the present invention showing off-board projection electrodes that are segmented.

FIG. 4 is a block diagram of a first embodiment showing that the location of the different projector electrode segments may also be modified.

FIG. 5 is a block diagram of a second embodiment showing that the projector electrodes may all be on-board electrodes.

FIG. 6 is a block diagram of a second embodiment showing that it is possible to combine both off-board and on-board projector electrodes segments in a single touch and proximity sensor.

FIG. 7 is a block diagram of a close-up view of projector electrodes disposed within gaps between the X and Y electrodes of the touch sensor.

FIG. 8 is a flowchart showing the method of the first embodiment of the invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “proximity sensor”, “touch and proximity sensor”, “touch panel”, “touchpad” and “touch screen”, except when explicitly distinguished from the other terms.

The present invention is directed to improving or extending a range of operation of a touch sensor that may also be capable of operating as a proximity sensor. A touch sensor may be limited in a detection range and only be capable of detecting objects that make physical contact with a touch sensitive surface. However, in a first embodiment of the invention, a touch sensor may be modified in order to include an ability to sense one or more objects before they make contact with the touch sensor, and may be referred to in this document as a touch and proximity sensor.

The ability of a touch and proximity sensor to be able to detect objects before they make contact with a touch sensitive surface using capacitance sensing technology may be a function of the strength of an electric field that is generated above the touch sensitive surface by electrodes in the touch and proximity sensor. An object that perturbs or influences the electric field generated by the touch and proximity sensor may be detectable. It may follow that the further that an electric field can be generated from the touch and proximity sensor, the further an object may be detected away its surface and its movement tracked.

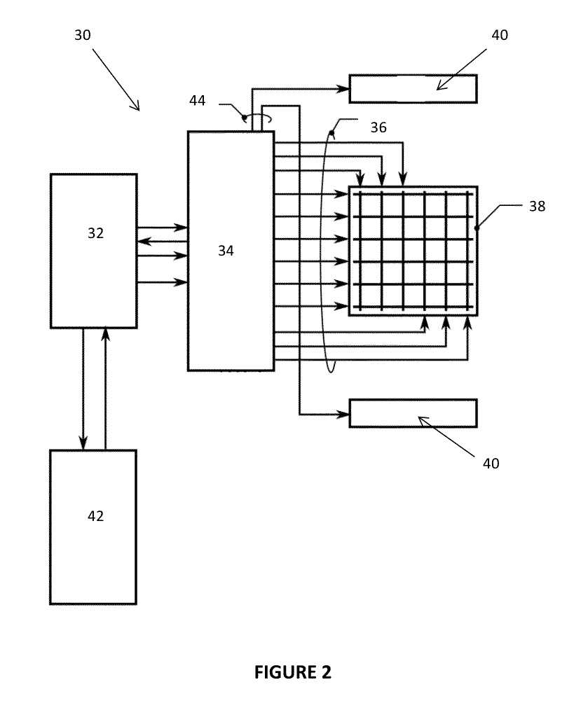

A touch and proximity sensor that may be used to implement the principles of the first embodiment of the present invention is shown in a block diagram in FIG. 2. The components of the first embodiment of a touch and proximity sensor 30 may include a microcontroller 32 coupled to a touch and proximity sensing capacitance detection circuit 34. The capacitance detection circuit 34 may have electrodes 36 that are coupled to an electrode grid that may be arranged in a co-planar and orthogonal arrangement commonly referred to as an X and Y electrode grid that may be referred to hereinafter as a touch sensor 38. Operation of the touch and proximity sensor 30 may be enhanced in this first embodiment by adding additional metal electrodes which may be conductive surfaces that are driven by electrodes 36 that are receiving drive signals from the capacitance detection circuit 34.

It should be understood that the touch and proximity sensor 30 may be in communication with a host 42. The host 42 may receive the touch and proximity data. The host 42 may be any system that is capable of receiving or using the touch and proximity data of the touch and proximity sensor 30. For example, the host 42 may be a portable electronic appliance such as a cellular telephone, a smartphone or a tablet computer, or it may be a stationary appliance such as a desktop computer, an automated teller machine (ATM) or a kiosk.

In the first embodiment, electrical field projecting electrodes or just “projector electrodes” may be arranged in different physical layouts or configurations. In the first embodiment, a first configuration for projector electrodes 40 and shown in FIG. 2 may be an off-board projector. An off-board projector may have projector electrodes 40 that are not disposed among or interspersed within the electrodes of the touch sensor 38 but are instead disposed around the perimeter of the touch sensor.

The projector electrodes 40 may have several features that may be important to the present invention. For example, the projector electrodes 40 may be wires or they may be planar electrodes. The projector electrodes 40 may create an electric field using whatever drive signal is provided by the capacitance detection circuit 34. The shape of the electric field may be influenced by the shape of the projector electrodes 40. The shape of the projector electrodes 40 may be an elongated rectangle. However, the shape may vary in order to achieve specific operational characteristics without departing from the scope of the present invention.

The projector electrodes 40 may be disposed in a symmetric or a non-symmetric arrangement around the touch sensor 38. However, symmetric placement of the projector electrodes 40 may enable a detectable object to be detected at a same distance from any outer edge or perimeter of the touch sensor 38. While FIG. 2 shows the projector electrodes 40 above and below the touch sensor 38, the projector electrodes 40 may be disposed to the right and left, or both above, below, right and left of the touch sensor.

It is noted that symmetry of the projector electrodes 40 around the touch sensor 38 may only be important when trying to achieve uniformity of detection distance around the touch sensor. Accordingly, the first embodiment may be operated using a single projector electrode 40 or a plurality of projector electrodes.

Another aspect of the first embodiment may be the size defined as the area of the projector electrodes 40 when they are formed as planar surfaces and not as only wires. When there is more than on projector electrode, the projector electrodes 40 may be equal in area to the area that is bounded by the electrode grid on the touch sensor 38. More specifically, the area of the touch sensor 38 is defined as the area within the X and Y electrodes that define the outer boundaries of the touch sensor. The total area of the touch sensor 38 may then be divided equally among the projector electrodes 40 such that the sum of the area of the projector electrodes is approximately equal to the area of the touch sensor 38.

It should be understood that the projector electrodes 40 may have a total area that is above or below the total area of the touch sensor 38 and still be within the scope of the present invention.

The purpose in making the areas of the projector electrodes 40 approximately or substantially equal to the area of the touch sensor 38 may be that when the areas are substantially equal, the electric field of the projector electrodes may have a maximum effect on the distance at which a detectable object may be detected by the touch sensor. In other words, the distance performance of the touch sensor 38 may be maximized to the greatest degree when the areas are approximately equal. Making the area of the projector electrodes 40 less than or greater than the area of the touch sensor 38 may not improve or may have less improvement on the distance performance of the touch and proximity sensor 30.

Accordingly, the projector electrodes 40 may improve performance of the touch sensor 38, but only up to the point at which the areas of the touch sensor and the projector electrodes are approximately equal.

It should be understood that the distance of the projector electrodes 40 from the touch sensor 38 may be exaggerated in FIG. 2, and should not be considered as an accurate or limiting depiction of the actual distance of the projector electrodes from the touch sensor.

The projector electrodes 40 may all be adjacent to the touch sensor 38 so that the electric field generated by the projector electrodes may have its greatest effect on the sensitivity of the touch sensor. It should be understood that sensitivity may refer to distance sensitivity, directional sensitivity or both.

The distance of each of the projector electrodes 40 from an edge of the touch sensor 38 may be modified in order to change the distance sensitivity of the touch sensor or to modify directional sensitivity. In other words, the location and the strength of the electric fields generated by each of the projector electrodes 40 may be modified in order to have an effect on distance sensitivity and directional sensitivity or both.

The capacitance detection circuit 34 may be electrically coupled to the projector electrodes 40 via pathway electrodes 44. There may be a unique pathway electrode 44 to each of the projector electrodes 40, or the pathway may be shared.

The drive signal that is generated from the capacitance detection circuit 34 to the projector electrodes 40 may vary depending on a mode of operation of the touch and proximity sensor 30. For example, when operating in a proximity detection and/or tracking mode, the touch and proximity sensor 30 may use the projector electrodes 40. However, in a close proximity or touch detection and/or tracking mode, the touch and proximity sensor 30 may not use the projector electrodes 40. The projector electrodes 40 may not be used in order to save on power. Another reason for not using the projector electrodes 40 is that they may interfere with touch sensitivity or operation of the touch sensor 38.

As stated previously, when the projector electrodes 40 are in operation, they may receive a drive signal. The drive signal may be the same drive signal that is sent to drive electrodes in the touch sensor 38. In contrast, when the projector electrodes 40 are not in operation, they may be electrically floating or grounded. The state of the projector electrodes 40 may be selected in order to minimize interference, decrease power use or for other reasons.

In another aspect of the present invention, the electric field generated by the projector electrodes 40 may be a controllable electric field. For example, the projector electrodes 40 may be used to steer or direct the electric field as it extends outwards in order to have increased directional sensitivity of the touch sensor 38. For example, if there are two projector electrodes 40, the signal one of the projector electrode may be made stronger than the signal on a different projector electrode. The result may be an electric field that is not symmetrical, but instead extends further out from the projector electrode having the stronger signal.

The purpose of making the signal on one projector electrode 40 stronger than on another projector electrode is that distance sensitivity is then increased in the direction of the projector electrode having the stronger signal. This may be useful when detection from a particular direction is more important than detection of an object approaching the touch sensor 38 from another direction.

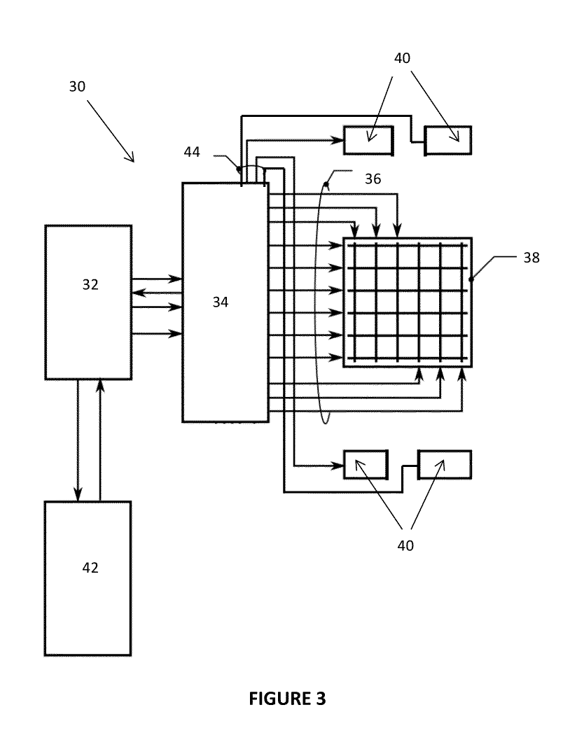

FIG. 3 shows another aspect of the first embodiment. In this figure, the projector electrodes 40 may be segmented. Different segments of the projector electrodes 40 may be activated at different times in order to change directional sensitivity, the shape of the electric field, or other aspects of operation of the touch and proximity sensor 30. The number of segments should not be considered as limited by the example shown in FIG. 3. More projector electrode 40 segments may be used in each location. Furthermore, the number of projector electrode 40 segments may not be equal on different sides of the touch sensor 38. This may enable an inherent directional sensitivity by just activating all of the projector electrode 40 segments.

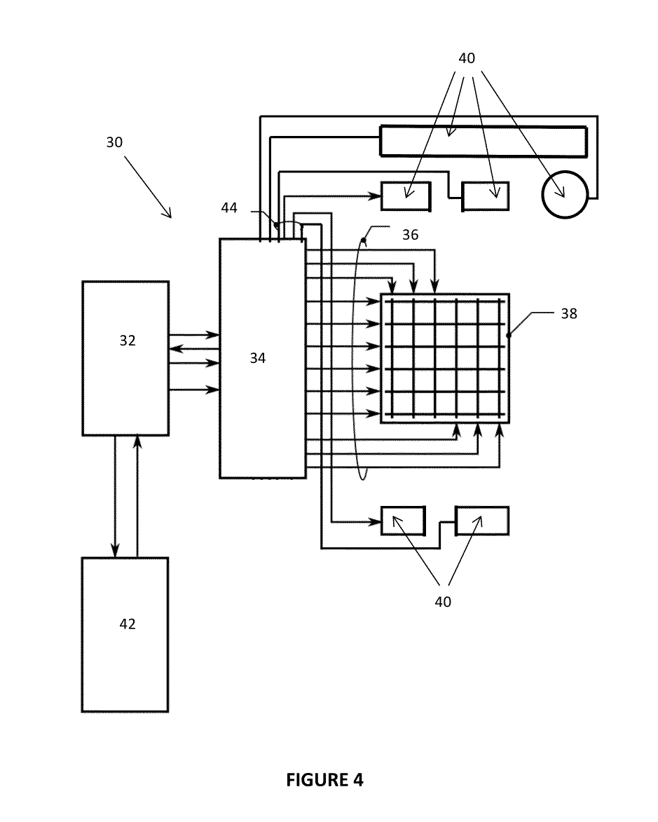

FIG. 4 shows in another aspect of the first embodiment that the location of the different projector electrode 40 segments may also be modified. For example, the projector electrode 40 segments may be arranged in different patterns or they may have different geometrical shapes as shown. Thus the shape of the projector electrode 40 segments and the layout may both be used to modify the sensitivity of the touch sensor 38.

In another aspect of the present invention, the projector electrodes 40 may be comprised of a solid planar surface or a mesh material. What is important is that the projector electrodes 40 be capable of generating the desired electric field.

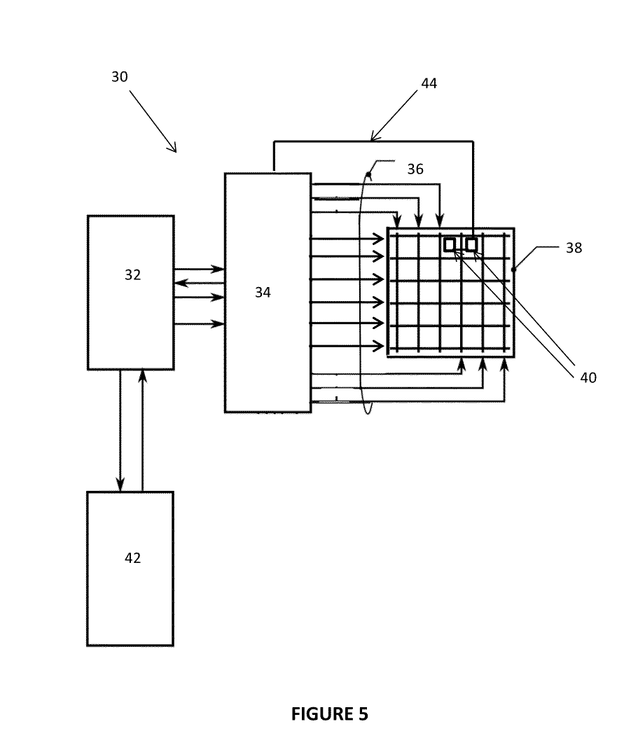

FIG. 5 is a block diagram of a second embodiment of the present invention. In the second embodiment of the present invention, the projector electrodes 40 may all be on-board electrodes, wherein the projector electrodes 40 are not separate from the substrate of the touch sensor 38 but may all be within the boundaries of the touch sensor. Thus the same substrate used for the X and Y electrode grid may also be used for the projector electrodes 40. The projector electrodes 40 may be co-planar with the electrodes of the touch sensor 38 or they may be disposed on a different plane or layer of a substrate.

In this second embodiment, the space or the gaps between the X and Y electrodes of the touch sensor 38 may be at least partially filled with the projector electrodes 40. Any number of the gaps may be filled with projector electrodes 40.

In this second embodiment, the projector electrodes 40 are segmented but coupled together using vias or other means of coupling to form a large but segmented projector electrode. It should be understood that the projector electrodes 40 may operate as one single large projector electrode or as individually controllable segments. In addition, there may be even more than one segment of the projector electrodes 40 within each gap.

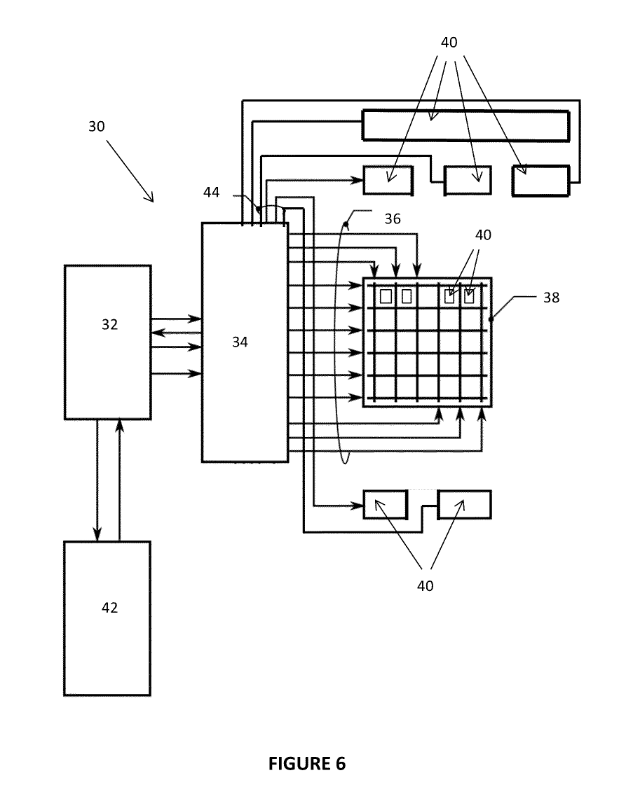

In an alternative embodiment shown in FIG. 6, the present invention may combine both off-board and on-board projector electrodes 40 segments in a single touch and proximity sensor 30. In such an arrangement, the segmented projector electrodes 40 may be formed outside of the boundary of the X and Y electrodes of the touch sensor 38 but may or may not be coupled to the segments that are inside the boundaries of the touch sensor.

It is noted that copper, ITO, steel and aluminum are all suitable materials for the projector electrodes 40. Thus, all conductive materials may be suitable for the projector electrodes 40.

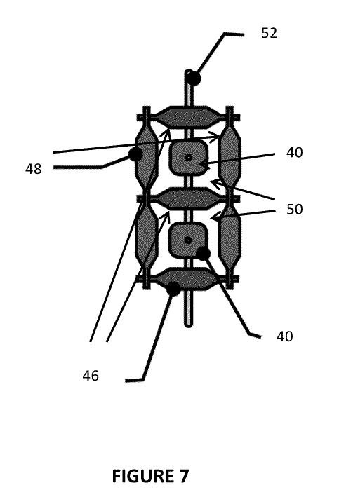

FIG. 7 is a close-up top view of a small portion of X and Y electrodes of a touch sensor 38. The touch sensor 38 shows two gaps 50 and an example of how the plurality of projector electrode 40 segments may be disposed in the gaps between the X and Y electrodes 46, 48 of the touch sensor 38. FIG. 5 shows a plurality of X electrodes 46 and a plurality of Y electrodes 48. The X electrodes 46 may be on a first plane, the Y electrodes 48 may be on a second plane, the projector electrodes 40 may be on the first or the second plane, and a projector electrode interconnect 52 may be on a fourth plane.

A ground plane may be inserted between the fourth plane of the projector electrode interconnect 52 and the first and second planes. The ground plane may be used to reduce the effect of the projector interconnect 52 on the touch sensor 38. There may also be more than one projector electrode interconnect 52 present if one or more of the projector electrode 40 segments are operating independently of each other.

In all of the embodiments of the invention, there may be different modes of operation wherein the behavior of the touch and proximity sensor may be changed in order to make adjustments to sensitivity. Sensitivity may be another way to define the distance at which one or more objects may be detected and the movement tracked. There may be up to four different modes of operation of the touch and proximity sensor in this embodiment.

Mode 1 may be defined as the mode of operation that may operate when the object is at its greatest detectable distance from the touch and proximity sensor. If there are multiple objects or an object with appendages, it may only be possible to know that at least one object is present, but not how many objects or appendages on the object are actually present. Accordingly, an “object” herein may me multiple objects or an object with multiple appendages, such as a hand with fingers.

Mode 2 may be defined as the mode of operation that may operate when the object is closer to the touch and proximity sensor sufficient to enable the motion of movement of the object, but not of appendages on the object if any.

Mode 3 may be defined as the mode of operation that may operate when the object or objects may be detected and location determined in a three dimensional volume of space. In other words, more than one object may be detected and tracked before the objects have made contact with the surface of the touch and proximity sensor, and the distance from the surface may also be determined for each object.

Finally, mode 4 may be defined as the mode of operation that may operate when the object or objects have made contact with the surface of the touch and proximity sensor.

It should be understood that the touch and proximity sensor may be able to operate in more than one mode of operation at the same time, or it may only be able to operate in a single mode of operation, depending upon the circumstances. For example, modes 3 and 4 may be capable of operation at the same time. In summary, the mode of operation of this embodiment may be defined as:

Mode 1—basic object presence.

Mode 2—object motion gestures may be tracked.

Mode 3—tracking individual finger positions above the surface of the touch and proximity sensor.

Mode 4—tracking finger positions on the surface of the touch and proximity sensor.

Each mode of operation may be characterized by the functions that are performed. In this embodiment, more than one function may be performed during each mode of operation. These functions include but should not be considered as limited to 1) reporting useful metrics for determining object behavior, 2) estimating and reporting the metrics of prior modes of operation, and 3) using mutual capacitance to make the measurements.

There may also be unique metrics that are reported for each mode of operation. In this embodiment the unique results reported for each mode of operation may include but is not limited to:

Mode 1 result: object proximity.

Mode 2 results: identification of multiple objects, determining a location for each object but not a distance, determining a signal size for each object, determining a velocity of each object, and detection of swiping motion.

Mode 3 and 4 results: reporting a three dimensional location for each object, including the signal size which may be used as an approximation of distance.

The stimulus used for each mode of operation may be chosen in order to help increase the sensitivity of the particular mode of operation. Modes of operation may use measurements that have been constructed to use unipolar drive patterns as much as possible. The drive patterns used may also drive the largest possible area of the touch sensor's electrodes.

For modes of operation 1 and 2, the projector electrodes 40 may be driven with the same signal as the sense electrodes of the touch sensor 38. In contrast, for modes 3 and 4, the projector electrodes 40 may not be used because they may interfere with operation of the touch sensor 30, or they may add no benefit. When not in use, the projector electrodes 40 may be left floating or connected to ground.

For mode 1 when the projector electrodes may be operating and the object being detected is just coming in to range, two drive signal patterns may be used in this embodiment. When a first drive signal pattern is used, all of the touch sensor 38 electrodes may be used as sense electrodes and the projector electrodes 40 may be set to toggle using a positive toggle phase from the first drive signal pattern. The second drive signal pattern may reverse the polarity of the projector electrodes 40. The difference in signal strength between the two signals may be used to determine the distance of an object. The difference in signal strength may also be used to increase immunity of the touch sensor 38 to low frequency electric field noise.

In this embodiment, the touch sensor 38 may be comprised of two layers of orthogonal electrodes, a top layer or parallel electrodes which are orthogonal to but co-planar with and a bottom layer or parallel electrodes. Mode 1 may operate with or without using the projector electrodes 40. For mode 1 when the projector electrodes 40 are not used, two drive signal patterns may be used. In order to increase the sensitivity of the touch sensor 38, the electrodes on the top-most layer of the touch sensor 38 may be used as sense electrodes, while the first drive signal pattern uses all of the electrodes on the bottom-layer to toggle with a positive toggle phase. A second drive signal pattern reverses the polarity of the projector electrodes 40. The difference between the two signals received by the sensor electrodes is used to determine the distance of an object. The difference is signal strength is also used to increase immunity to low frequency electric field noise.

It should be understood that when using mode 1, the purpose of the mode is only to detect the presence of an object. It may also be possible to determine the location of an object, but that may not be possible if the object is too far away. It is analogous to using glasses that are out of focus. While the presence of the object is detectable, its exact location is less certain. The location is left to be determined in mode 2.

A question of operation of this embodiment is when should the system change from operating in mode 1 and move to mode 2. It is an aspect of the present invention to be able to change modes of operation on-the-fly. In other words, once a detected signal reaches a certain threshold in size or strength, it may be possible to move from mode 1 to mode 2 because it has been determined through experimentation that it is possible to get a higher resolution image of the approaching object by operating in mode 2.

Regarding mode 1, the deliverable information from the touch and proximity sensor may include the presence of an object and possibly an approximate distance. Because distance of the object may be difficult to determine in mode 1, if certain assumptions are made about the nature of the detected object, it may be possible to tune the touch sensor 38 to detect objects at a farther distance or to determine a distance. For example, if it is assumed that the detected object is a human hand of average size, then the system may be tuned to detect an object of that size because of that assumption.

Mode 2 may provide the same information as mode 1 in this embodiment, but with the addition of information regarding the motion and the specific location of the object. For example, mode 2 may determine that an object moves from one side of the touch sensor 38 to the other in the three dimensional space above it. Mode 2 may deliver information regarding the whole object, and not individual parts or appendages such as fingers.

Mode 3 may provide the same information as mode 2, but with the addition of information regarding the position and movement of individual objects. For example, if the object is a hand with fingers, the individual fingers or fingertips may be not only detectable, but their movement may be tracked.

Mode 4 may be different from the other modes of operation because it may not provide information from the previous modes, but instead only reports data regarding the object or objects such as fingertips. The reason for this is that in this embodiment, mode 4 may not provide any proximity data. Mode 4 may only provide touch data. In an alternative embodiment, mode 4 may operate to provide touch and proximity data at the same time.

As aspect of this embodiment is that not only does it enable movement from one mode of operation to another mode, it also enables movement in either direction through the modes. Thus, when an object gets closer to the touch and proximity sensor, the logic of the present invention may change the sensitivity of the touch and proximity sensor 30 from mode 1, then to mode 2 when a signal threshold is reached, then from mode 2 to mode 3 when a different signal threshold is reached, then from mode 3 to mode 4 when a last signal threshold is reached.

However, the touch sensor 38 may also move backwards through the modes of operation as the object moves away from the touch sensor 38. The same signal thresholds may be used when moving from mode to mode in either direction.

In another aspect of this embodiment, the modes of operation may move any number of times from one mode to any adjacent mode and back again. Accordingly, the embodiment is not limited to direction of movement or the number of times that adjacent modes of operation may be activated.

After an object has been detected using mode 1 as a sensitivity setting for the touch sensor 38, the question may be to determine when to move the touch sensor to mode 2. There are factors that may be used to determine when to move from one mode to another. A first factor may be the speed with which an object appears may influence which mode is activated.

For example, if a palm of a hand appears rapidly, there may not be time to move from mode 1 to mode 2, then to mode 3 and finally to mode 4. Accordingly, the present invention may move directly from mode 1 to mode 4 when movement toward the touch sensor 38 is very rapid. For example, a speed threshold or a size threshold for the object may be used as detected in mode 1.

In this embodiment, the touch sensor 38 may use a mode transition frame counter for determining what action to take based upon the size or strength of a proximity signal. If the proximity signal is relatively small because the object is far away, then a mode transition frame counter is reset. If the proximity signal is below a set threshold for strength, then the next step may be to prepare for moving from mode 1 to mode 2 by resetting mode 2's swipe tracking information and preparing mode 2 for a new swipe. However, if the proximity signal is larger than a signal threshold for signal strength, then the mode transition frame counter may be used to track the number of consecutive frames that the object is detected. A frame may be a single detection cycle or other time period or number of detection cycles.

If several consecutive frames indicate the proximity signal is above the signal threshold, then both a fall-back frame counter and a mode transition frame counter may be reset, and the touch sensor 38 may be changed to mode 2.

Looking at mode 2 operation when using the projector electrodes 40, a sequence of drive signal patterns may be sent to the projector electrodes 40 with a unipolar toggle that may sweep a large collection of X electrodes on the touch sensor 38. Instead of the entire touch sensor 38 being an active sensor, the region of the touch sensor 38 that is active for sensing may be moved across the touch sensor from one side of the X electrodes to another, then from one side of the Y electrodes to another in order to gather location information about the X and Y location of the object, typically a hand, that is above the above the touch sensor 38.

In an alternative embodiment, when operating in mode 2 when not using projector electrodes 40, a sequence of patterns drives all the X electrodes except for the section being sensed (an X region of sensing), and a few electrodes on either side of the X region of sensing may also be left floating. The X region of sensing is then moved across the touch sensor 38 along the X electrodes.

This process may be repeated for the Y electrodes by driving a sequence of patterns along the Y electrodes except for the section being sensed (a Y region of sensing), and a few electrodes on either side of the Y region of sensing may also be left floating. In this way, the touch sensor 38 gathers information about the X and Y location of the object above the touch sensor 38.

When operating in mode 3, a multiplex and demultiplex sequence may be used to sense individual finger positions. The multiplex sequence may follow a pattern such as a Hadamard pattern, but the “all ones” pattern must also be run because useful information is derived therefrom.

Operation of a mode 4 is similar to operation of mode 3, but with a much lower capacitance detection circuit 34 gain.

The following is a detailed explanation for the first embodiment of the present invention. The first embodiment may use frames. A frame may be defined as a complete snapshot of all the signals present at each electrode junction on the touch sensor 38. Thus, when signals from the touch sensor 38 are being measured, as soon as a signal value is calculated for each junction within the touch sensor 38, a single frame may be complete. It should be understood that frames may typically be calculated at a rate of 100 frames per second in order to create the desired operation of the touch sensor 38. However, the frame rate may be faster or slower without departing from the embodiments of the invention. Thus, the frame rate may be as low as one or as high as a million frames per second. The frame rate itself is not important. What is important is how they are used in determining if or when to change from one mode to the next.

The frames may be used to determine when to move from mode to mode in touch sensor 38 operation. The first embodiment may use a mode transition frame counter and a fall-back frame counter as hereinafter explained.

The mode transition frame counter may be used to count the number of frames that a signal of an object has exceeded a signal threshold so that there may be a need to transition from the present mode to a next mode having higher resolution. The need may be caused by many factors. For example, the object may have come closer to the touch sensor 38 and more information can now be obtained about the object, such as position information. However, in order to prevent transitioning prematurely between modes, the object and its signal may need to be large enough over a number of consecutive frames.

For example, if the signal from an object has exceeded a signal threshold, the method begins the counting of frames. The mode transition frame counter is used to count down (or count up) the number of consecutive frames that the object is recognized as exceeding the signal threshold. If the object has a signal that exceeds the signal threshold for a predetermined number of consecutive frames, then the touch sensor 38 will transition from the present mode to the next higher mode of operation, as long as the present mode is mode 1, 2, or 3. In this embodiment, there is no higher mode than mode 4. However, if there were more modes, then the method would also function until the highest mode was reached.

It should be understood that while this embodiment includes 4 modes of operation, a greater or lesser number of modes of operation may be used and still be considered to be within the scope of the present embodiment of the invention. What is important is that there be at least two modes of operations.

Regarding the changing of modes, if the mode transition frame counter is set to five frames, and there are five consecutive frames where the object has a signal that exceeds the signal threshold, then the mode transition frame counter is reset, and the touch and proximity sensor 30 moves to the next mode having a higher resolution. However, if there are not five consecutive frames where the object has a signal that exceeds the signal threshold, then the mode transition frame counter is still reset as soon as the current number of consecutive frames is broken. For example, if there are three consecutive frames that the object is large enough but the fourth frame is not large enough, then the mode transition frame counter is immediately reset and counting of the mode transition frame counter begins again as soon as the object has a signal that exceeds the signal threshold.

It should be understood that the number of frames to be counted for the transition frame counter and the fall-back frame counter may be some value other than five. Furthermore, the transition frame counter and the fall-back frame counter may both have a different number of frames that that must be consecutive in order to change modes.

There is the possibility that the object does not have a signal that exceeds the signal threshold to justify moving the touch and proximity sensor 30 to the next higher resolution mode of operation, but actually becomes small enough so that the touch and proximity sensor needs to reduce the present sensing resolution and thus move from a higher resolution mode to a mode with less resolution. In order to determine when to move from a higher resolution mode to a mode with less resolution, the touch and proximity sensor 30 uses the fall-back frame counter.

The fall-back frame counter may be used much like the mode transition frame counter, only in reverse. Thus, if the object is determined to have a signal that is below the signal threshold and the signal is decreasing, or in other words the object is moving or has moved away from the touch and proximity sensor 30, the fall-back counter begins a countdown (or count-up) of the number of consecutive frames in which the object is determined to be too small for the present sensing mode.

If the fall-back counter completes a countdown, then the touch and proximity sensor 30 may move from the present mode to a next lower mode of resolution. However, the object may also change direction and begin to move closer to the touch and proximity sensor 30. Therefore, depending on whether the object has a signal that is getting smaller or larger, the appropriate frame counter will begin a countdown.

It should be understood that once the object is close enough to the touch and proximity sensor 30 that the highest resolution mode is in operation, the mode transition frame counter is no longer used, but only the fall-back frame counter may be active. In contrast, both the mode transition frame counter and the fall-back frame counter may potentially be in operation in all other modes of the touch and proximity sensor 30.

The purpose of the transition and fall-back frame counters is not only to introduce a delay into the transition from one mode of operation to the next, but also to prevent a rapid bouncing back-and-forth between modes. Thus, the method is not only more certain to ensure that the present mode should be abandoned, but also that the change from one mode to the next may appear to be a trend of movement of the object. The frame counters therefore create a de-bouncing or hysteresis effect for the method that controls movement between the different modes.

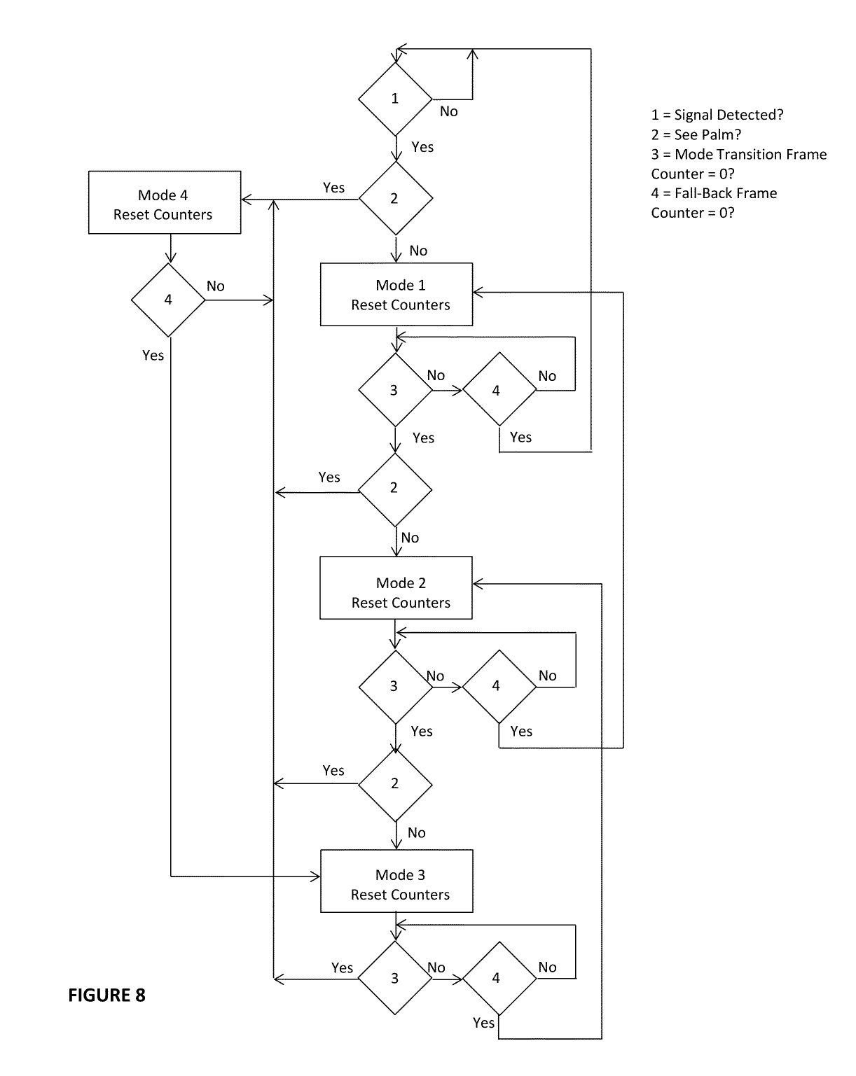

FIG. 8 is a flowchart of the embodiment of the method of determining a mode of operation. It should be understood that specific steps may be altered without changing the fundamental nature of the embodiment. The method may begin by looking for a signal of an object. When a signal is detected, the first step is to ask if the palm of the hand is being detected. The palm will have a large signal. If the object detected is large, then the object may have rapidly approached the touch and proximity sensor 30, and therefore the method may immediately move to the highest resolution mode, which is mode 4. However, if no large object is detected, then the method moves to mode 1 where the mode transition and fall-back frame counters are reset to an appropriate value.

The first step of mode 1 is to check to see if the object is getting large enough (either the signal is growing or has exceeded a signal threshold) to move to the next mode. If the object is growing in size or has exceeded a signal threshold, then the mode transition frame counter is decremented. The next step is to see if the object is small enough such that the method should ignore the object because it is too far away or no longer approaching. If the object is far away, then the fall-back frame counter is decremented. These loops continue until either the mode transition frame counter or the fall-back frame counter counts 5 consecutive frames. If either of the frame counters reaches zero, meaning that five consecutive frames meeting their criteria have been counted, then the mode transitions. If the mode transition frame counter has had five consecutive frames, then the next step is to see if the palm is being detected. If it is, then the method immediately transitions to mode 4. If not, then the method transitions to mode 2. If the fall-back frame counter has five consecutive frames, then the mode transitions back to mode 1.

The same processes are performed in each mode. If the method transitions to mode 3, then the same processes are performed. However, if the mode transition frame counter has five consecutive frames, there is no check for the palm because the next mode is mode 4. Mode 4 is performed until the fall-back counter has five consecutive frames and the method moves back to mode 3.

Alternatively, it may be possible to move from any mode to a pre-mode state where no signal is being detected and no mode is being performed, if the signal rapidly disappears and there is no time to actually move backward through the modes.

It should be understood that the countdowns performed by the frame counters may be increased or decreased in order to make the touch and proximity sensor 30 perform as desired.

An example of the embodiment may function as follows. A first step may be to provide a touch sensor including a substantially orthogonal array of X and Y electrodes. The next step is to continuously search for an object. When an object is detected, the touch sensor 38 may move to a first mode of operation. The first mode of operation may also be defined as a mode of first degree of sensitivity of the touch sensor.

The touch sensor 38 remains in the first mode of operation until a signal from the object exceeds a signal threshold for moving from the first mode to the second mode of operation. In order to reduce signal bounce, the signal must exceed the signal threshold for a predetermined number of measurement operations. A single measurement operation may be defined as measuring a signal for an object at each junction of the orthogonal array of X and Y electrodes.

If the object exceeds the signal threshold for a certain number of consecutive frames, then the touch sensor moves to a next higher mode of operation or resolution of the touch sensor because more information can be obtained about the object or objects.

However, if the signal from the object is consistently below the signal threshold for a consecutive number of frames, then the object may be moving away from the touch sensor, and the resolution may need to be reduced to a next lower mode of operation or no longer tracked if the lowest mode was already in operation.

In order to track the number of consecutive frames, counters are used to count down from a number of frames that must be consecutive in order to move to a higher or lower mode of operation. Therefore, after starting any mode of operation, a transition counter is assigned a full transition counter value that is used to count down to zero, and a fall-back counter is assigned a full fall-back counter value that is used to count down to zero. If the transition counter ever reaches zero, then the signal from the object has exceeded a signal threshold for a correct number of consecutive frames, and the mode transitions to a higher mode of resolution. However, if the count is ever interrupted, then the transition counter is reset to the full number of frames that must be counted in order to move to the higher mode of operation. The count is interrupted if the signal does not exceed the signal threshold for a frame.

Likewise, if the fall-back counter reaches zero, then the signal from the object has been below a signal threshold for a correct number of consecutive frames, and the mode transitions to a lower mode of operation or resolution. However, if the count is ever interrupted, then the fall-back counter is reset to the full number of frames that must be counted in order to move to the lower mode of operation. The count is interrupted if the signal exceeds the signal threshold for a frame.

Those skilled in the art will readily appreciate that many modifications are possible in the example embodiments without materially departing from this first embodiment or the invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for automatically controlling sensitivity of a touch and proximity sensor having distinct modes of operation that control sensitivity, said method comprised of:
providing a touch sensor including a substantially orthogonal array of X and Y electrodes;
detecting an object in a first mode of operation; and
moving to a next higher mode of sensitivity if a signal from the object exceeds a signal threshold for a predetermined number of measurement operations to thereby provide higher resolution of the object, or moving to a next lower mode of sensitivity if the signal from the object is below the signal threshold for a predetermined number of measurement operations and there is a next lower mode of sensitivity, or ceasing tracking of the object if there is no lower mode of sensitivity.

2. The method as defined in claim 1 wherein the method further comprises:
repeatedly capturing a frame representing measurement of a signal from each junction of the orthogonal array of X and Y electrodes;
moving to the next higher mode of sensitivity if the signal from the object exceeds a signal threshold for a predetermined number of consecutive frames; and
moving to the next lower mode of sensitivity if the signal from the object is below the signal threshold for a predetermined number of consecutive frames.

3. The method as defined in claim 2 wherein the step of moving to the next higher mode of sensitivity if the signal from the object exceeds the signal threshold for a predetermined number of consecutive frames further comprises:
assigning a transition counter to count the number of consecutive frames that the object exceeds the signal threshold; and
assigning a fall-back counter to count the number of consecutive frames that the object is below the signal threshold.

4. The method as defined in claim 3 wherein the method further comprises:
assigning the transition counter to have a full counter value for the number of consecutive frames that the signal from the object must exceed the signal threshold before moving the touch sensor to a higher mode of sensitivity;
decrementing the transition counter for each frame that the signal from the object exceeds the signal threshold; and
moving to a higher mode of operation if the transition counter reaches zero.

5. The method as defined in claim 4 wherein the method further comprises:
assigning the fall-back counter to have a full counter value for the number of consecutive frames that the signal from the object must be below the signal threshold before moving the touch sensor to a lower mode of sensitivity;
decrementing the fall-back counter for each frame that the signal from the object is below the signal threshold; and
moving to a lower mode of operation if the fall-back counter reaches zero.

6. The method as defined in claim 5 wherein the method further comprises resetting the transition counter to the full counter value if the signal from the object falls below the signal threshold before the transition counter reaches zero.

7. The method as defined in claim 6 wherein the method further comprises resetting the fall-back counter to the full counter value if the signal from the object exceeds the signal threshold before the fall-back counter reaches zero.

8. A method for automatically controlling sensitivity of a touch and proximity sensor having distinct modes of operation that control sensitivity, said method comprised of:
providing a touch sensor including a substantially orthogonal array of X and Y electrodes;
repeatedly capturing a frame representing a signal for an object at each junction of the orthogonal array of X and Y electrodes when an object is detected;
finding a signal in a frame and beginning a first mode of the touch and proximity sensor;
moving to a second mode of operation if the signal exceeds a first signal threshold for a first consecutive number of frames, or moving back to the first mode of operation if the signal is below the first signal threshold for a second consecutive number of frames;
moving to a third mode of operation if the signal exceeds a second signal threshold for a third consecutive number of frames, or moving back to the second mode of operation if the signal is below the second signal threshold for a fourth consecutive number of frames; and
moving to a fourth mode of operation if the signal exceeds a third signal threshold for a fifth consecutive number of frames, or moving back to the third mode of operation if the signal is below the third signal threshold for a sixth consecutive number of frames.

9. The method as defined in claim 1 wherein the method further comprises moving from the first mode or the second mode directly to the fourth mode of operation if a large object exceeds a fourth signal threshold for a seventh consecutive number of frames.
